(19) United States
(12) Patent Application Publication
(10) Pub. No.: US 2022/0170643 A1
(43) Pub. Date: Jun. 2, 2022

(54) COOKTOP APPLIANCE AND METHOD FOR OPERATING A LIGHT DISPLAY

(71) Applicant: Haier US Appliance Solutions, Inc., Wilmington, DE (US)

(72) Inventor: Paul Bryan Cadima, Crestwood, KY (US)

(21) Appl. No.: 17/109,576

(22) Filed: Dec. 2, 2020

(51) Int. Cl. F24C 7/08; G05G 1/10

(52) U.S. Cl. CPC F24C 7/083; G05G 1/105

(57) ABSTRACT

A cooktop appliance may include a housing, a heating element, a user input, a light display, and a controller. A method of operation may include may include determining a heating event at the heating element and illuminating a variable band along the light display in response determining the heating event. The variable band may include a continuous illuminated region having a predetermined color along the light display. The method may further include decreasing an annular length of the variable band progressively according to a predetermined countdown pattern in response to illuminating the variable band.

### FIELD OF THE INVENTION

The present subject matter relates generally to systems for aiding cooking operations, and more particularly to systems for enhancing cooking engagement and convenience with a cooktop appliance.

### BACKGROUND OF THE INVENTION

Cooktop or range appliances generally include heating elements for heating cooking utensils, such as pots, pans, and griddles. A variety of configurations can be used for the heating elements located on the cooking surface of the cooktop. The number of heating elements or positions available for heating on the range appliance can include, for example, four, six, or more depending upon the intended application and preferences of the buyer. These heating elements can vary in size, location, and capability across the appliance.

Gas burners generally include an orifice that directs a flow of gaseous fuel into a fuel chamber. Between the orifice and the fuel chamber, the gaseous fuel entrains air, and the gaseous fuel and air mix within the fuel chamber before being ignited and discharged out of the fuel chamber through a plurality of flame ports. Normally aspirated gas burners rely on the energy available in the form of pressure from the fuel supplied to the gas burner to entrain air for combustion. Because the nominal pressure in households is relatively low, there is a practical limit to the amount of primary air that a normally aspirated gas burner can entrain.

In general, there is a trend in the cooking appliance market toward high-powered forced air burners in order to speed up cooking tasks. However, while higher powered burners offer very fast cooking times, that can also more quickly overheat food or the appliance itself if operated for excessive periods of time. A user that is accustomed only to older, less capable appliances may underestimate the rate of heating of newer, higher powered burners.

This may be especially true for common user input assemblies, which generally include a separate user input or knob for each burner. In some instances, a single light is positioned adjacent to each user input. Each light may be configured to emit a single color, for example, when the adjacent user input is set in an active position (i.e., a position that directs heating or activation of the corresponding heat element).

Although existing systems may be useful for indicating or conveying a single piece of information, such systems present several challenges and shortcomings, especially in the context of a higher powered burner. For instance, the single light may be difficult to see. Moreover, a single light may fail to provide any indication of whether a higher powered function has been initiated, let alone how long it has been initiated or whether special attention is required.

As a result, it would be useful to provide a cooktop appliance or system addressing one or more of the above identified issues. In particular, it would be advantageous to provide a cooking appliance capable of quickly and clearly communicating feedback and instructions for the cooktop appliance.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooktop appliance is provided. The cooktop appliance may include a housing, a heating element, a user input, a light display, and a controller. The housing may define a top surface and a control panel. The heating element may be mounted to the housing at the top surface. The user input may be mounted to the housing at the control panel. The light display may be positioned about the user input at the control panel, the light display may be configured to selectively emit one or more illumination colors. The controller may be operably coupled to the light display. The controller may be configured to initiate a countdown operation at the light display. The countdown operation may include determining a heating event at the heating element and illuminating a variable band along the light display in response determining the heating event. The variable band may include a continuous illuminated region having a predetermined color along the light display. The countdown operation may further include decreasing an annular length of the variable band progressively according to a predetermined countdown pattern in response to illuminating the variable band.

In another exemplary aspect of the present disclosure, a method of operating a cooktop appliance is provided. The method may include. The method may include determining a heating event at a heating element of a gas burner assembly. The method may also include illuminating a variable band along the light display in response determining the heating event. The variable band may include a continuous illuminated region having a predetermined color along the light display. The method may further include decreasing an annular length of the variable band progressively according to a predetermined countdown pattern in response to illuminating the variable band.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top, plan view of a cooktop appliance according to exemplary embodiments of the present disclosure.

FIG. 2 provides a schematic view of a gas burner according to exemplary embodiments of the present disclosure.

FIG. 3 provides a side elevation view of the example gas burner of FIG. 2.

FIG. 4 provides an exploded view of the example gas burner of FIG. 2.

FIG. 5 provides a section view of the example gas burner of FIG. 2.

FIG. 6 provides another section view of the example gas burner of FIG. 2.

FIG. 7 provides a perspective view of an injet of the example gas burner of FIG. 2.

FIG. 8 provides an exploded view of the injet of FIG. 7.

FIG. 9 provides a section view of the injet of FIG. 7.

FIG. 10 provides a front plan view of an input assembly according to exemplary embodiments of the present disclosure.

FIG. 11 provides a front plan view of the exemplary user input assembly of FIG. 5, wherein a diffuser ring has been removed for clarity.

FIG. 12 provides a front plan view of the exemplary user input assembly of FIG. 5, wherein a cooking operation has been initiated.

FIG. 13 provides a front plan view of the exemplary user input assembly of FIG. 5, wherein a boost sequence of a cooking operation has been initiated.

FIG. 14 provides a front plan view of the exemplary user input assembly of FIG. 5, wherein the boost sequence of the cooking operation has been initiated and a portion of a countdown interval has elapsed.

FIG. 15 provides a front plan view of the exemplary user input assembly of FIG. 5, wherein the boost sequence of the cooking operation has been initiated and a further portion of a countdown interval has elapsed.

FIG. 16 provides a front plan view of the exemplary user input assembly of FIG. 5, wherein the boost sequence of the cooking operation has been initiated and a still further portion of a countdown interval has elapsed.

FIG. 17 provides a flow chart illustrating a method of operating a system according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

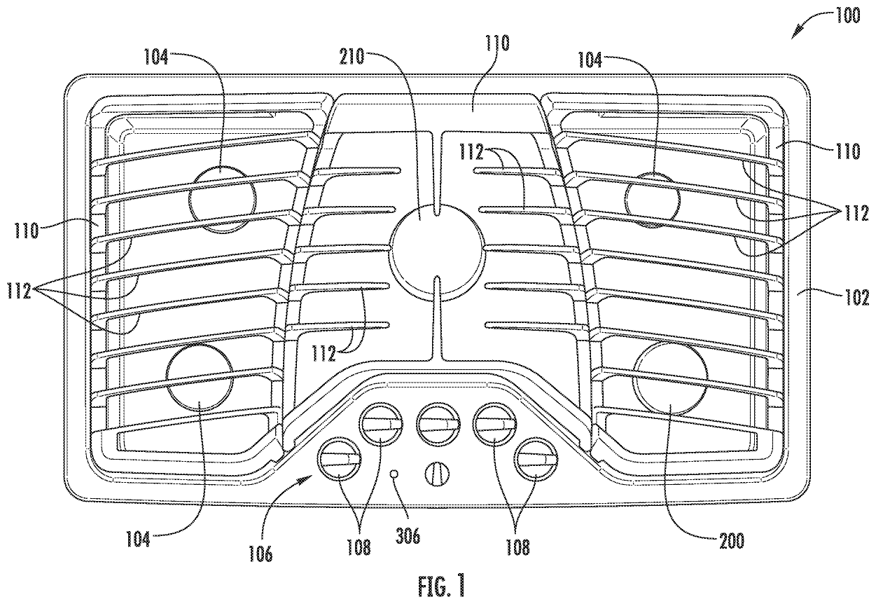

FIG. 1 illustrates a cooktop appliance 100 according to exemplary embodiments of the present disclosure. Cooktop appliance 100 may be, e.g., fitted integrally with a surface of a kitchen counter or may be configured as a slide-in cooktop unit. Cooktop appliance 100 includes a top panel 102 that includes one or more heating sources, such as heating elements 104 for use in, e.g., heating or cooking. In general, top panel 102 may be constructed of any suitably rigid and heat resistant material capable of supporting heating elements 104, cooking utensils, grates 110, or other components of cooktop appliance 100. By way of example, top panel 102 may be constructed of enameled steel, stainless steel, glass, ceramics, and combinations thereof.

According to the illustrated example embodiment, a user interface panel or control panel 106 is located within convenient reach of a user of cooktop appliance 100. For this example embodiment, control panel 106 includes control knobs 108 that are each associated with one of heating elements 104. Control knobs 108 allow the user to activate each heating element 104 and regulate the amount of heat input each heating element 104 provides to a cooking utensil located thereon, as described in more detail below.

Cooktop appliance 100 is generally referred to as a “gas cooktop,” and heating elements 104 are gas burners. For example, one or more of the gas burners in cooktop appliance may be a gas burner 300 described below. As illustrated, heating elements 104 are positioned on or within top panel 102 and have various sizes, as shown in FIG. 1, so as to provide for the receipt of cooking utensils (i.e., pots, pans, etc.) of various sizes and configurations and to provide different heat inputs for such cooking utensils. In addition, cooktop appliance 100 may include one or more grates 110 configured to support a cooking utensil, such as a pot, pan, etc. In general, grates 110 include a plurality of elongated members 112, e.g., formed of cast metal, such as cast iron. The cooking utensil may be placed on the elongated members 112 of each grate 110 such that the cooking utensil rests on an upper surface of elongated members 112 during the cooking process. Heating elements 104 are positioned underneath the various grates 110 such that heating elements 104 provide thermal energy to cooking utensils above top panel 102 by combustion of fuel below the cooking utensils.

According to the illustrated example embodiment, a user interface panel or control panel 106 is located within convenient reach of a user of cooktop appliance 100. As illustrated, control panel 106 may be provided on cooktop appliance 100. Although shown at front portion of cooktop appliance 100, another suitable location or structure (e.g., a backsplash) for supporting control panel 106 may be provided in alternative embodiments. In some embodiments, control panel 106 includes one or more user inputs or controls, such as one or more of a variety of electrical, mechanical, or electro-mechanical input devices. For this example embodiment, control panel 106 includes control knobs 108 that are each associated with one of heating elements 104. Control knobs 108 allow the user to activate each heating element 104 and regulate the amount of heat input each heating element 104 provides to a cooking utensil located thereon, as described in more detail below.

A controller 308 is operably coupled (e.g., wirelessly coupled or electrically coupled) to and in communication with control panel 106 and control knobs 108 through which a user may select various operational features and modes and monitor progress of cooktop appliance 100. In certain embodiments, one or more of the control knobs 106 is included with a multicolor light display 410 as part of an input or assembly 400 that is operably coupled to controller 308. In certain embodiments, control panel 106 represents a general purpose I/O (“GPIO”) device or functional block.

As shown, controller 308 is operably coupled to control panel 106 and its control knobs 106. Controller 308 may also be operably coupled to various operational components of cooktop appliance 100 as well, such as heating elements (e.g., 104, 300), sensors, etc. Input/output (“I/O”) signals may be routed between controller 308 and the various operational components of cooktop appliance 100. Thus, controller 308 can selectively activate and operate these various components. Various components of cooktop appliance 100 are operably coupled to controller 308 via one or more communication lines such as, for example, conductive signal lines, shared communication busses, or wireless communications bands.

In some embodiments, controller 308 includes one or more memory devices and one or more processors. The processors can be any combination of general or special purpose processors, CPUs, or the like that can execute programming instructions or control code associated with operation of cooktop appliance 100. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 308 may be constructed without using a processor, for example, using a combination of discrete analog or digital logic circuitry (such as switches, amplifiers, integrators, comparators, flip-flops, AND gates, and the like) to perform control functionality instead of relying upon software.

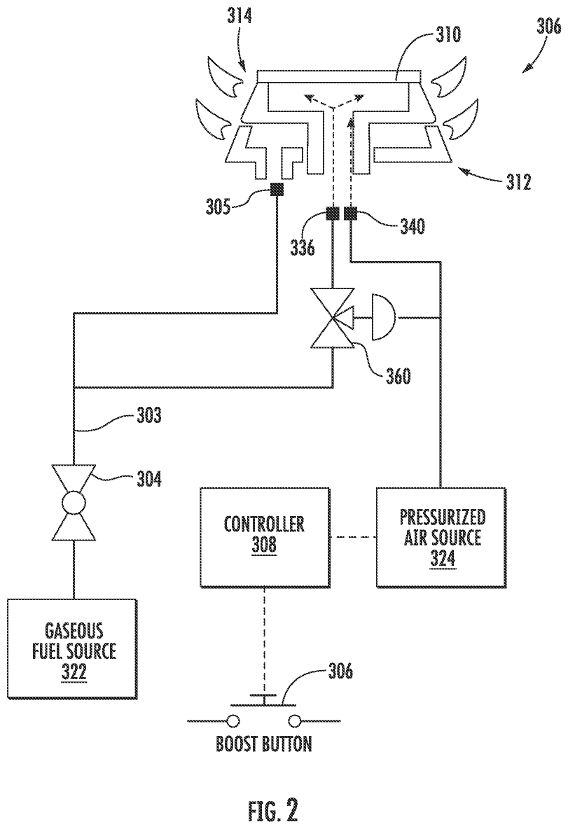

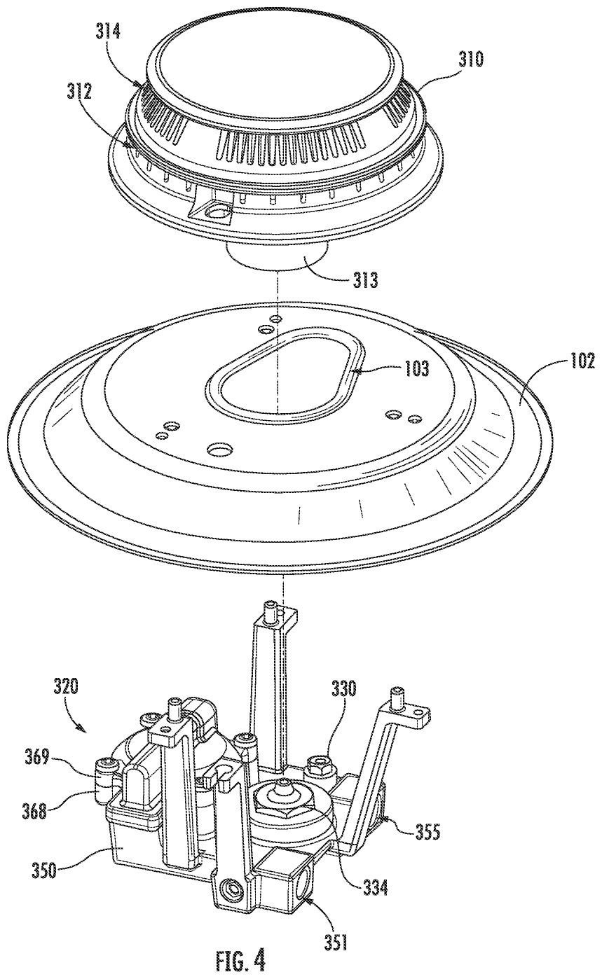

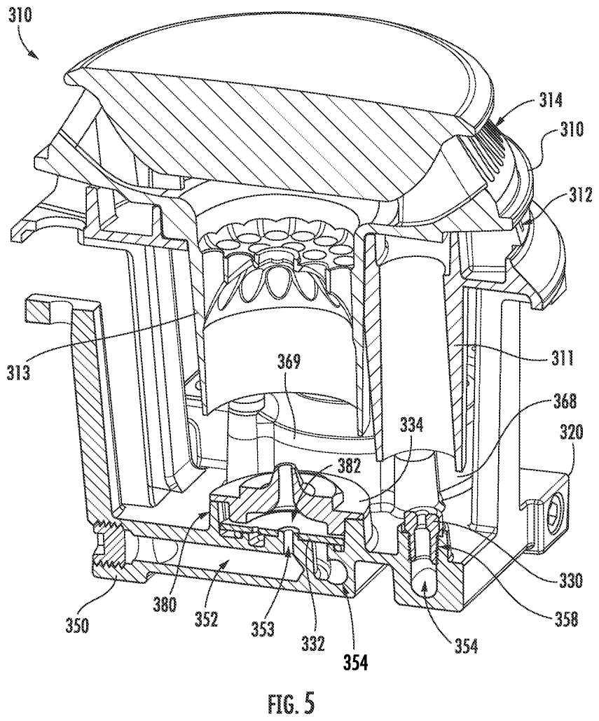

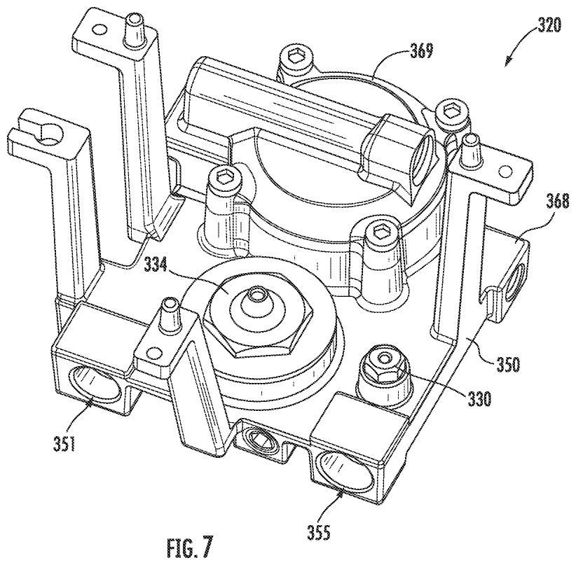

Turning now to FIGS. 2 through 9, a gas burner 300 according to an example embodiment of the present disclosure is described. Gas burner 300 may be used in cooktop appliance 100, e.g., as one of heating elements 104. Thus, gas burner 300 is described in greater detail below in the context of cooktop appliance 100. However, it will be understood that gas burner 300 may be used in or with any other suitable cooktop appliance in alternative example embodiments.

Gas burner 300 includes a burner body 310. Burner body 310 defines a plurality of naturally aspirated flame ports 312 and a plurality of forced induction flame ports 314. Naturally aspirated flame ports 312 may be distributed in a ring on burner body 310. Similarly, forced induction flame ports 314 may be distributed in a ring on burner body 310. Burner body 310 may also be stacked, e.g., such that forced induction flame ports 314 are positioned above naturally aspirated flame ports 312 on burner body 310. Thus, e.g., the ring of forced induction flame ports 314 may be positioned above the ring of naturally aspirated flame ports 312 on burner body 310. Burner body 310 may be positioned on top panel 102, e.g., in the manner described above for burner body 212 of second gas burner 210.

Naturally aspirated flame ports 312 may receive gaseous fuel from a gaseous fuel source 322, such as a natural gas line or propane line, when a user actuates one of control knobs 108 to adjust a control valve 304. Thus, e.g., a supply line 303 for naturally aspirated flame ports 312 may extend from gaseous fuel source 322 to an orifice 305 for naturally aspirated flame ports 312, and control valve 304 may be coupled to supply line 303.

Forced induction flame ports 314 may be plumbed in parallel to naturally aspirated flame ports 312 in gas burner 300. Thus, forced induction flame ports 314 may be capable of receiving gaseous fuel from gaseous fuel source 322 when the user actuates one of control knobs 108 to adjust control valve 304. Gas burner 300 also includes features for supplying air from a pressurized air source 324, such as an air pump or fan, to forced induction flame ports 314. Thus, forced induction flame ports 314 may operate with a higher flow rate of gaseous fuel or air compared to naturally aspirated flame ports 312. As an example, forced induction flame ports 314 may be activated by pressing a boost burner button 306 on control panel 106. In response to a user actuating boost burner button 306, pressurized air source 324 may be activated (e.g., with controller 308). Gas burner 300 also includes features for blocking the flow of gaseous fuel to forced induction flame ports 314 unless pressurized air source 324 is activated or pressurized air is suppled to forced induction flame ports 314, as discussed in greater detail below.

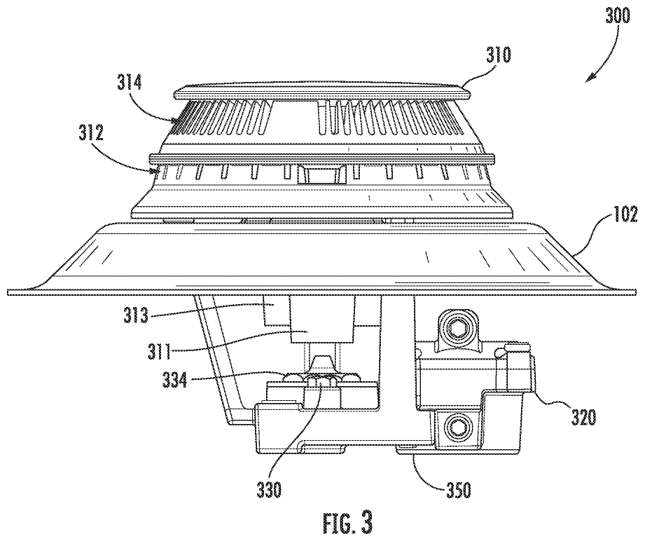

With reference to FIGS. 3 through 9, gas burner 300 also includes an injet assembly 320. Injet assembly 320 may be positioned below top panel 102, e.g., below an opening 103 of top panel 102. Conversely, burner body 310 may be positioned on top panel 102, e.g., over opening 103 of top panel 102. Thus, burner body 310 may cover opening 103 of top panel 102 when burner body 310 is positioned on top panel 102. When burner body 310 is removed from top panel 102, injet assembly 320 below top panel 102 is accessible through opening 103. Thus, e.g., a fuel orifice(s) of gas burner 300 on injet assembly 320 may be accessed by removing burner body 310 from top panel 102, and an installer may reach through opening 103 (e.g., with a wrench or other suitable tool) to change out the fuel orifice(s) of gas burner 300.

Injet assembly 320 is configured for directing a flow of gaseous fuel to naturally aspirated flame ports 312 of burner body 310. Thus, injet assembly 320 may be coupled to gaseous fuel source 322. During operation of gas burner 300, gaseous fuel from gaseous fuel source 322 may flow from injet assembly 320 into a vertical Venturi mixing tube 311. In particular, injet assembly 320 includes a first gas orifice 330 that is in fluid communication with a gas passage 354. A jet of gaseous fuel from gaseous fuel source 322 may exit injet assembly 320 at first gas orifice 330 and flow towards vertical Venturi mixing tube 311. Between first gas orifice 330 and vertical Venturi mixing tube 311, the jet of gaseous fuel from first gas orifice 330 may entrain air into vertical Venturi mixing tube 311. Air and gaseous fuel may mix within vertical Venturi mixing tube 311 prior to flowing to naturally aspirated flame ports 312 where the mixture of air and gaseous fuel may be combusted.

Injet assembly 320 is also configured for directing a flow of air and gaseous fuel to forced induction flame ports 314 of burner body 310. Thus, as discussed in greater detail below, injet assembly 320 may be coupled to pressurized air source 324 in addition to gaseous fuel source 322. During boosted operation of gas burner 300, a mixed flow of gaseous fuel from gaseous fuel source 322 and air from pressurized air source 324 may flow from injet assembly 320 into an inlet tube 313 prior to flowing to forced induction flame ports 314 where the mixture of gaseous fuel and air may be combusted at forced induction flame ports 314.

In addition to first gas orifice 330, injet assembly 320 also includes a second gas orifice 332, a mixed outlet nozzle 334 and an injet body 350. Injet body 350 defines an air passage 352 and a gas passage 354. Air passage 352 may be in fluid communication with pressurized air source 324. For example, a pipe or conduit may extend between pressurized air source 324 and injet body 350, and pressurized air from pressurized air source 324 may flow into air passage 352 via such pipe or conduit. Gas passage 354 may be in fluid communication with gaseous fuel source 322. For example, a pipe or conduit may extend between gaseous fuel source 322 and injet body 350, and gaseous fuel from gaseous fuel source 322 may flow into gas passage 354 via such pipe or conduit. In certain example embodiments, injet body 350 defines a single inlet 351 for air passage 352 through which the pressurized air from pressurized air source 324 may flow into air passage 352, and injet body 350 defines a single inlet 355 for gas passage 354 through which the pressurized air from gaseous fuel source 322 may flow into gas passage 354.

First gas outlet orifice 330 is mounted to injet body 350, e.g., at a first outlet 358 of gas passage 354. Thus, gaseous fuel from gaseous fuel source 322 may exit gas passage 354 through first gas outlet orifice 330, and gas passage 354 is configured for directing a flow of gaseous fuel through injet body 350 to first gas outlet orifice 330. On injet body 350, first gas outlet orifice 330 is oriented for directing a flow of gaseous fuel towards vertical Venturi mixing tube 311 or naturally aspirated flame ports 312, as discussed above.

Second gas orifice 332 and injet body 350, e.g., collectively, form an eductor mixer 380 within a mixing chamber 382 of injet body 350. Eductor mixer 380 is configured for mixing pressurized air from air passage 352 with gaseous fuel from gas passage 354 in mixing chamber 382. In particular, an outlet 353 of air passage 352 is positioned at mixing chamber 382. A jet of pressurized air from pressurized air source 324 may flow from air passage 352 into mixing chamber 382 via outlet 353 of air passage 352. Second gas orifice 332 is positioned within injet body 350 between mixing chamber 382 and gas passage 354. Gaseous fuel from gaseous fuel source 322 may flow from gas passage 354 into mixing chamber 382 via second gas orifice 332. As an example, second gas orifice 332 may be a plate that defines a plurality of through holes 333, and the gaseous fuel in gas passage 354 may flow through holes 333 into mixing chamber 382.

The jet of pressurized air flowing into mixing chamber 382 via outlet 353 of air passage 352 may draw and entrain gaseous fuel flowing into mixing chamber 382 via second gas orifice 332. In addition, as the gaseous fuel is entrained into the air, a mixture of air and gaseous fuel is formed within mixing chamber 382. From mixing chamber 382, the mixture of air and gaseous fuel may flow from mixing chamber 382 via mixed outlet nozzle 334. In particular, mixed outlet nozzle 334 is mounted to injet body 350 at mixing chamber 382, and mixed outlet nozzle 334 is oriented on injet body 350 for directing the mixed flow of air and gaseous fuel from mixing chamber 382 into inlet tube 313 or towards forced induction flame ports 314, as discussed above.

Burner body 310 may be positioned over injet body 350, e.g., when burner body 310 is positioned top panel 102. In addition, first gas orifice 330 may be oriented on injet body 350 such that first gas orifice 330 directs the flow of gaseous fuel upwardly towards vertical Venturi mixing tube 311 and naturally aspirated flame ports 312. Similarly, mixed outlet nozzle 334 may be oriented on injet body 350 such that mixed outlet nozzle 334 directs the mixed flow of air and gaseous fuel upwardly towards inlet tube 313 and forced induction flame ports 314.

First and second gas orifices 330, 332 may be removeable from injet body 350. First and second gas orifices 330, 332 may also be positioned on injet body 350 directly below burner body 310, e.g., when burner body 310 is positioned on top panel 102. Thus, e.g., first and second gas orifices 330, 332 may be accessed by removing burner body 310 from top panel 102, and an installer may reach through opening 103 (e.g., with a wrench or other suitable tool) to change out first and second gas orifices 330, 332.

Injet assembly 320 also includes a pneumatically actuated gas valve 360. Pneumatically actuated gas valve 360 may be positioned within injet body 350, and pneumatically actuated gas valve 360 is adjustable between a closed configuration and an open configuration. In the closed configuration, pneumatically actuated gas valve 360 blocks the flow of gaseous fuel through gas passage 354 to second gas orifice 332, eductor mixer 380 or mixed outlet nozzle 334. Conversely, pneumatically actuated gas valve 360 permits the flow of gaseous fuel through gas passage 354 to second gas orifice 332/eductor mixer 380 in the open configuration. Pneumatically actuated gas valve 360 is configured to adjust from the closed configuration to the open configuration in response to the flow of air through air passage 352 to outlet 353 of air passage 352. Thus, e.g., pneumatically actuated gas valve 360 is in fluid communication with air passage 352 and opens in response to air passage 352 being pressurized by air from pressurized air source 324. As an example, pneumatically actuated gas valve 360 may be positioned on a branch of air passage 352 relative to outlet 353 of air passage 352.

It will be understood that first gas outlet orifice 330 may be in fluid communication with gas passage 354 in both the open and closed configurations of pneumatically actuated gas valve 360. Thus, first gas outlet orifice 330 may be positioned on gas passage 354 upstream of pneumatically actuated gas valve 360 relative to the flow of gas through gas passage 354. Thus, e.g., pneumatically actuated gas valve 360 may not regulate the flow of gas through second gas orifice 332 but not first gas outlet orifice 330.

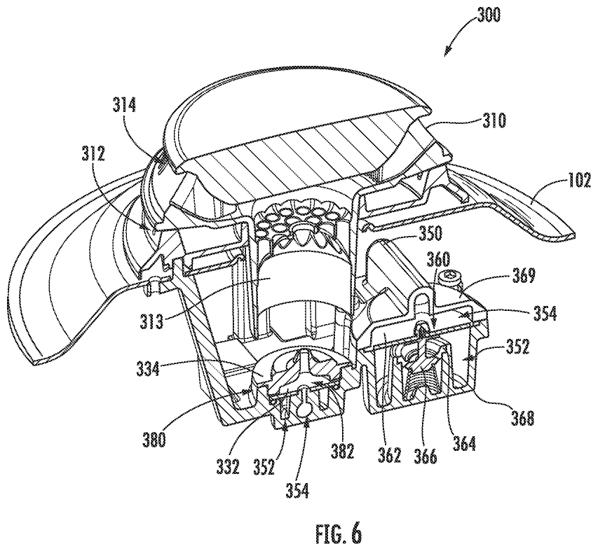

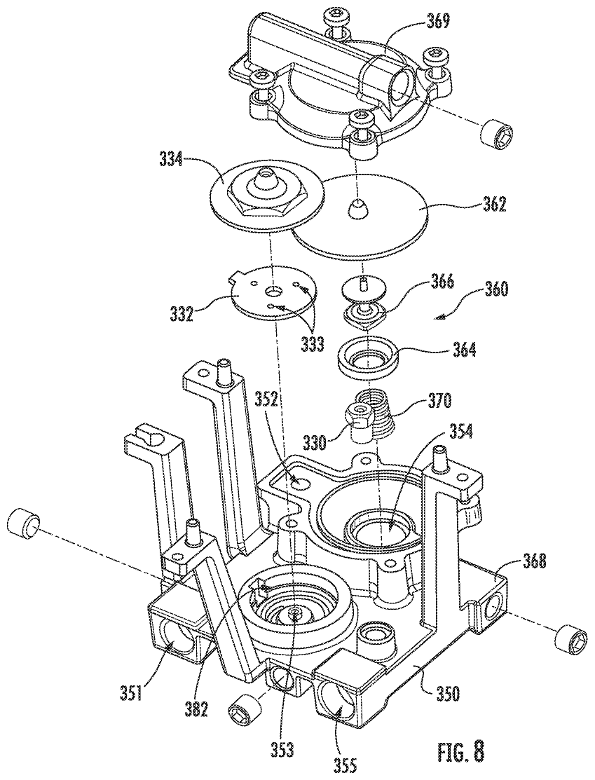

As shown in FIGS. 6 and 8, pneumatically actuated gas valve 360 includes a diaphragm 362, a seal 364 and a plug 366. Diaphragm 362 is positioned between air passage 352 and gas passage 354 within injet body 350. For example, diaphragm 362 may be circular and may be clamped between a first injet body half 368 and a second injet body half 369. In particular, first and second injet body halves 368, 369 may be fastened together with diaphragm 362 positioned between first and second injet body halves 368, 369.

Seal 364 is mounted to injet body 350 within gas passage 354. Plug 366 is mounted to diaphragm 362, e.g., such that plug 366 travels with diaphragm 362 when diaphragm 362 deforms. Plug 366 is positioned against seal 364 when pneumatically actuated gas valve 360 is closed. A spring 370 may be coupled to plug 366. Spring 370 may urge plug 366 towards seal 364. Thus, pneumatically actuated gas valve 360 may be normally closed.

When air passage 352 is pressurized by air from pressurized air source 324, diaphragm 362 may deform due to the pressure of air in air passage 352 increasing, and plug 366 may shift away from seal 364 as diaphragm 362 deforms. In such a manner, diaphragm 362, seal 364 and plug 366 may cooperate to open pneumatically actuated gas valve 360 in response to air passage 352 being pressurized by air from pressurized air source 324. Conversely, diaphragm 362 may return to an undeformed state when air passage 352 is no longer pressurized by air from pressurized air source 324, and plug 366 may shift against seal 364. In such a manner, diaphragm 362, seal 364 and plug 366 may cooperate to close pneumatically actuated gas valve 360 in response to air passage 352 no longer being pressurized by air from pressurized air source 324.

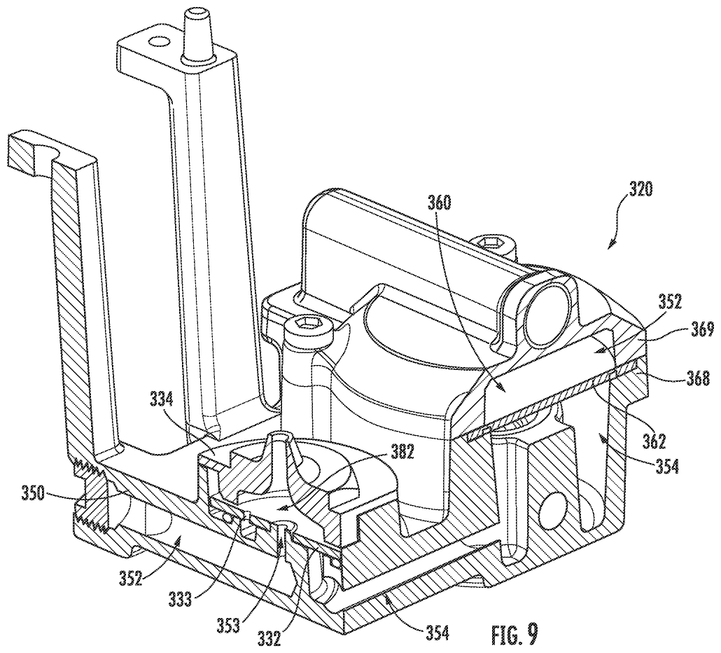

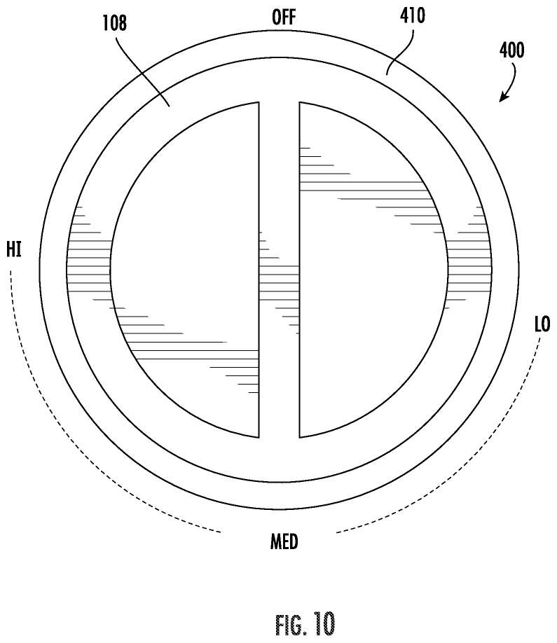

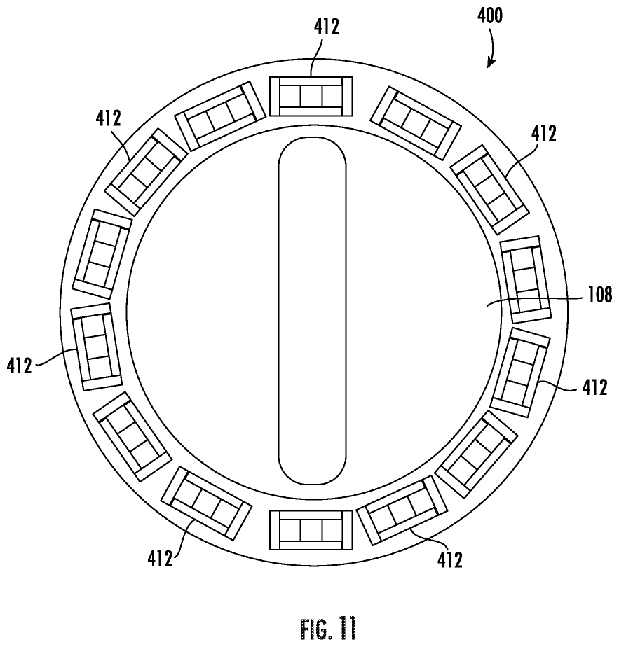

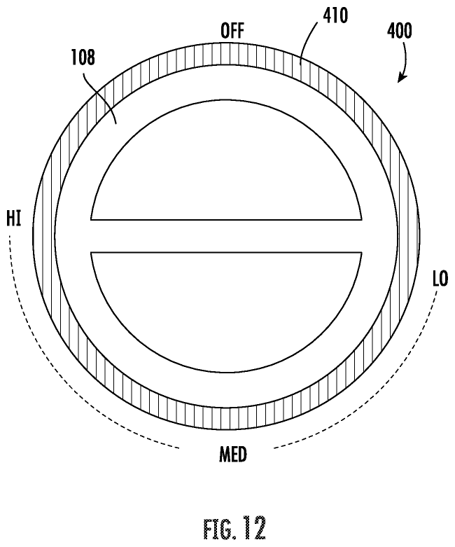

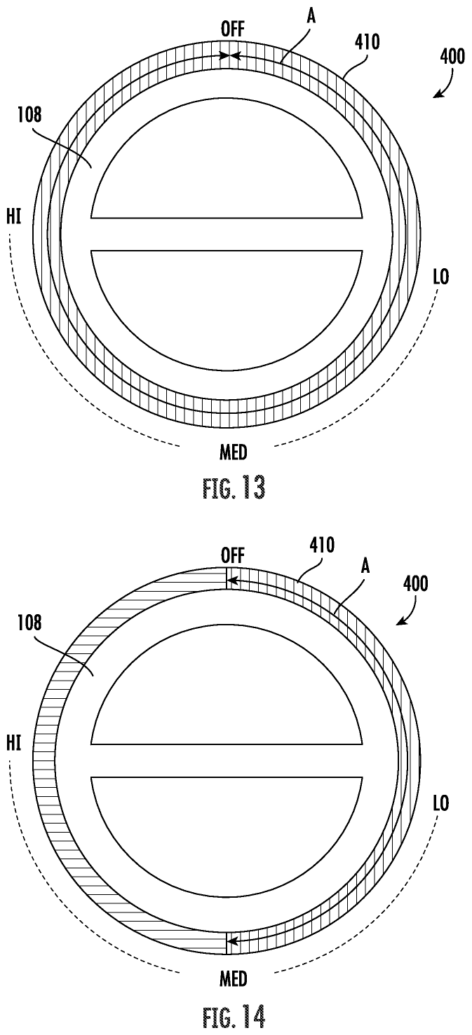

Turning now to FIGS. 10 through 16, as noted above, one or more input assemblies 400 having a corresponding control knob 108 and multicolor light display 410 may be provided at or on control panel 106. As shown, multicolor light display 410 is positioned about corresponding control knobs 108. A plurality of light sources 412 (e.g., multicolored light emitting diodes—LEDs) are, for example, circumferentially spaced apart from each other. Thus, at least one light source 412 may be located at a discrete position or location relative to another light source 412 surrounding the corresponding control knob 108 (e.g., light source 412 is circumferentially spaced apart from another light source 412 by 180°). In optional embodiments, a diffuser ring or light guide (e.g., formed from a transparent or translucent polymer) may be disposed in front of the light sources 412 to blend or diffuse the light transmitted from adjacent light sources 412, as would be understood.

Generally, multicolor light display 410 is configured to selectively emit a plurality of illumination colors in a ring about the corresponding knob 108. During operations (e.g., cooking operations), multicolor light display 410 may thus be selectively activated to project various colors of light (i.e., light waves along visible color spectrum). In some such embodiments, multicolor light display 410 selectively projects different illumination colors of the plurality of illumination colors in one or more illumination bands that extend, at least in part, about the corresponding knob 108. The specific illumination color (i.e., one illumination color of the plurality of formation colors) that is projected at a given point in time may relate to one or more specific conditions within the appliance 100.

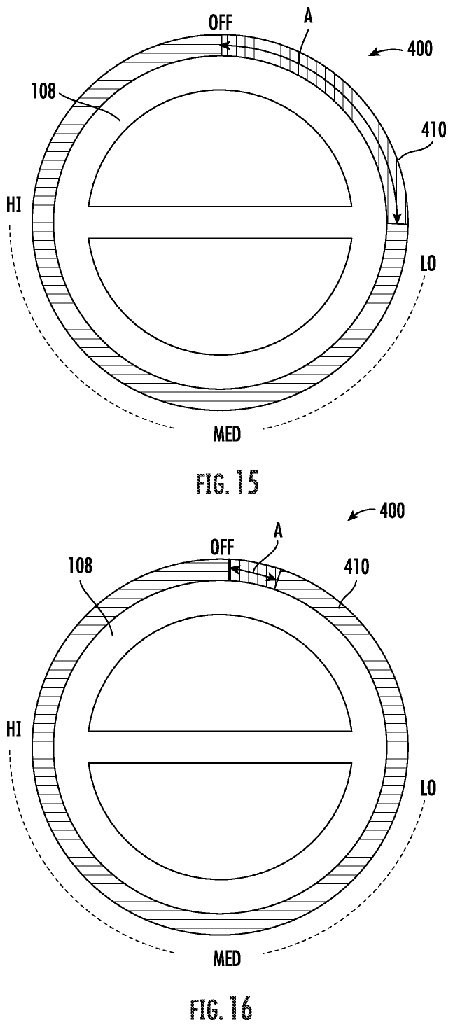

As an example, following activation of the corresponding burner 300, such as to ignite naturally aspirated flame ports 312, light display 410 may illuminate the entire annular portion of light display 410 in a single color (e.g., an activation color, such as blue). Subsequently, the forced induction flame ports 314 may be activated (e.g., in response to a user pressing boost burner button 306). Following activation of the forced induction flame ports 314, the color of illumination for the light display 410 may be changed (e.g., to a countdown color, such as red), such as to form a continuous annular band and a countdown pattern (e.g., a countdown interval may be started at controller 308). As the countdown pattern elapses, the annular band of the new (e.g., countdown) color may also change or vary. Thus, the changed illumination color may be defined according to a variable band 420 that may decrease with the countdown. Specifically, the annular length A of the variable band 420 may decrease progressively according to the countdown pattern. Thus, adjacent light sources 412 may be sequentially dimmed or changed (e.g., back to the active color or another/third color) as the countdown elapses. The dimmed or changed portion may form a complementary band 422 that increases while the variable band 420 decreases. In the case of a countdown interval, the decrease in the annular band may be linear or proportional to the remaining countdown interval. For instance, FIG. 14 may illustrate the state of the variable band 420 after the countdown interval is halfway elapsed. Similarly, FIG. 15 may illustrate the state of the variable band 420 after seventy-five percent of the countdown interval has elapsed. FIG. 16 may illustrate the state of the variable band 420 after ninety percent of the countdown interval has elapsed. As the countdown interval completely elapses, the variable band 420 may be reduced to zero (e.g., such that the entire display is again illuminated with the active color or in a third color).

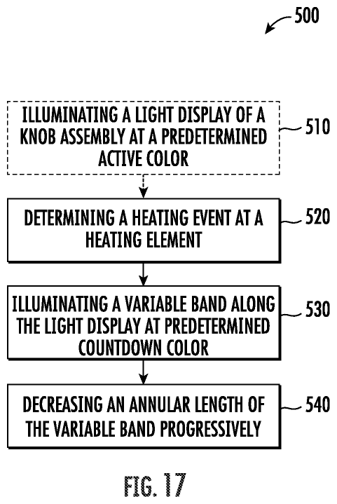

Turning now to FIG. 17, various methods may be provided for use with appliance 100 in accordance with the present disclosure. In general, the various steps of methods as disclosed herein may, in exemplary embodiments, be performed by a controller (e.g., controller 308) as part of an operation that the controller 308 is configured to initiate (e.g., a cooking operation). During such methods, the controller 308 may receive inputs and transmit outputs from various other components of the appliance 100. For example, the controller 308 may send signals to and receive signals from control panel 106, control knobs 108, boost button 308, input assembly 400, light display 410, one or valves, sensors, etc. Such methods advantageously facilitate the communication of information (e.g., to a user) that is easily and readily understood. In certain embodiments, such methods may advantageously facilitate communication to a user concerning the status of one or more gas burner assemblies 300 (e.g., at the forced induction flame ports thereof).

FIG. 17 depicts steps performed in a particular order for purpose of illustration and discussion. Those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

At 510, the method 500 includes the optional step of illuminating the light display of a knob assembly at a predetermined active color. In particular, the light display may be illuminated at the predetermined active color in response to activating the corresponding heating element (e.g., gas burner assembly). This activation may occur or be determined by, for instance, detecting rotation or placement of the control knob to an active position, or otherwise moving an input to ignite a particular burner, as would be understood. For instance, the plurality of naturally aspirated flame ports may be activated to ignite the fuel therefrom. In some embodiments, a continuous illumination band may be established by illumination at the predetermined active color. As an example, multiple light sources disposed about the control knob may be activated to emit the predetermined active color such that a visually unbroken ring of illumination surrounds the control knob.

At 520, the method 500 includes determining a heating event at the heating element (e.g., following 510). Specifically, 520 includes determining some heat-generation or heat-altering action has occurred at the corresponding gas burner assembly. As an example, 520 may include detecting activation of the boost burner. Thus, the heating event may be activation of the boost burner. In other words, the plurality of forced induction flame ports may be activated to ignite the fuel therefrom. Such activation may be detected, for instance, in response to a user pressing the boost burner button (or another suitable input).

At 530, the method 500 includes illuminating a variable band along the light display (e.g., in response to 520). As described above, the variable band generally includes a continuous illuminated region having a predetermined (e.g., countdown) color along the light display. In certain embodiments, 530 includes immediately changing the illumination ring of the predetermined active color into a ring of the predetermined countdown color. At such a state, the variable band may thus extend annularly around the entire annular or circumferential length of the light display. Thus, the annular length of the variable band at the start of 530 may span the entire circumferential length (e.g., 180°) of the light display.

At 540, the method 500 includes decreasing the annular length of the variable band progressively (e.g., following or in response to 530). In other words, the annular length may reduce gradually. For instance, the light sources of the light display may be deactivated or changed colors about the control knob (e.g., sequentially along the circumferential length of the light display). Thus, a complementary band may gradually illuminate or increase in annular length in tandem with the decrease of the variable band. In other words, the complementary band may progressively take the place of the variable band. If the illumination color is changed (e.g., back to the activation color or to another/third color) with decreasing the annular length of the variable band, the complementary band may define an illuminated area that is distinct in color from the variable band. By contrast, if the illumination color is not changed with decreasing the annular length of the variable band, the complementary band may define an unilluminated area that is visually distinct from the illumination of the variable band.

In some embodiments, the reduction of the annular length of the variable band occurs according to a predetermined countdown pattern. Generally, any suitable pattern or sequence may be provided. In exemplary embodiments, the predetermined pattern comprises at a predetermined rate to reduce the variable band to zero. For instance, the predetermined rate may be a linear rate of reduction in relation to a predetermined countdown interval. Thus, the relative annular length of the variable band may be proportional to the relative amount (e.g., percentage) of time left in a countdown interval. Such an interval may, as an example, be initiated or started at 520. In such embodiments, the countdown interval can be a predetermined continuous period of time during which the boost burner is permitted to be active. The reduction of the variable band to zero may, in turn, coincide with deactivation of the boost burner (e.g., halting flames at the corresponding boost burner ports). Moreover, reduction of the variable band to zero may result in the entire circumferential length of the light display being illuminated in a different color (e.g., the activation color or another/third color) or unilluminated to indicate to a user that the countdown interval has elapsed and, for instance, that the boost burner is no longer active.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas burner assembly for a cooktop appliance, the gas burner assembly comprising:
a housing defining a top surface and a control panel;
a heating element mounted to the housing at the top surface;
a user input mounted to the housing at the control panel;
a light display positioned about the user input at the control panel, the light display being configured to selectively emit one or more illumination colors; and
a controller operably coupled to the light display, the controller being configured to initiate a countdown operation at the light display, the countdown operation comprising
determining a heating event at the heating element,
illuminating a variable band along the light display in response determining the heating event, the variable band comprising a continuous illuminated region having a predetermined color along the light display, and
decreasing an annular length of the variable band progressively according to a predetermined countdown pattern in response to illuminating the variable band.

2. The gas burner assembly of claim 1, wherein the predetermined color is a predetermined countdown color, and wherein the countdown operation further comprises
illuminating, prior to determining the heating event, the light display at a predetermined active color, the predetermined active color being different from the predetermined countdown color.

3. The gas burner assembly of claim 2, wherein decreasing the annular length of the variable band comprises increasing a complementary band progressively in place of the variable band, and wherein the complementary band is illuminated at the predetermined active color.

4. The gas burner assembly of claim 2, wherein decreasing the annular length of the variable band comprises increasing a complementary band progressively in place of the variable band, and wherein the complementary band is unilluminated.

5. The gas burner assembly of claim 2, wherein decreasing the annular length of the variable band comprises increasing a complementary band progressively in place of the variable band, wherein the complementary band is illuminated at a predetermined replacement color, and wherein the predetermined replacement color is different from the predetermined active color and the predetermined countdown color.

6. The gas burner assembly of claim 1, wherein the heating element comprises
a primary burner comprising a plurality of primary flame ports in fluid communication with a primary fuel chamber for receiving a flow of primary fuel; and
a boost burner comprising a plurality of boost burner ports coaxial with the plurality of primary flame ports in fluid communication with a boost fuel chamber for receiving a flow of boost fuel,
wherein the heating event comprises activation of the boost burner to ignite the boost burner ports.

7. The gas burner assembly of claim 1, wherein the predetermined pattern comprises at a predetermined rate to reduce the variable band to zero.

8. The gas burner assembly of claim 7, wherein the predetermined rate is a linear rate of reduction in relation to a predetermined countdown interval.

9. The gas burner assembly of claim 1, wherein the light display comprises a plurality of multi-colored LEDs disposed about the user input, and wherein decreasing the variable band comprises changing an illumination color of sequential LEDs of the plurality of multi-colored LEDs.

10. A method of operating a light display positioned about a user input of a gas burner assembly, the method comprising:
determining a heating event at a heating element of the gas burner assembly;
illuminating a variable band along the light display in response determining the heating event, the variable band comprising a continuous illuminated region having a predetermined color along the light display, and
decreasing an annular length of the variable band progressively according to a predetermined countdown pattern in response to illuminating the variable band.

11. The method of claim 10, wherein the predetermined color is a predetermined countdown color, and wherein the method further comprises illuminating, prior to determining the heating event, the light display at a predetermined active color, the predetermined active color being different from the predetermined countdown color.

12. The method of claim 11, wherein decreasing the annular length of the variable band comprises increasing a complementary band progressively in place of the variable band, and wherein the complementary band is illuminated at the predetermined active color.

13. The method of claim 11, wherein decreasing the annular length of the variable band comprises increasing a complementary band progressively in place of the variable band, and wherein the complementary band is unilluminated.

14. The method of claim 11, wherein decreasing the annular length of the variable band comprises increasing a complementary band progressively in place of the variable band, wherein the complementary band is illuminated at a predetermined replacement color, and wherein the predetermined replacement color is different from the predetermined active color and the predetermined countdown color.

15. The method of claim 10, wherein the heating element comprises
a primary burner comprising a plurality of primary flame ports in fluid communication with a primary fuel chamber for receiving a flow of primary fuel; and
a boost burner comprising a plurality of boost burner ports coaxial with the plurality of primary flame ports in fluid communication with a boost fuel chamber for receiving a flow of boost fuel,
wherein the heating event comprises activation of the boost burner to ignite the boost burner ports.

16. The method of claim 10, wherein the predetermined pattern comprises at a predetermined rate to reduce the variable band to zero.

17. The method of claim 16, wherein the predetermined rate is a linear rate of reduction in relation to a predetermined countdown interval.

18. The method of claim 10, wherein the light display comprises a plurality of multi-colored LEDs disposed about the user input, and wherein decreasing the variable band comprises changing an illumination color of sequential LEDs of the plurality of multi-colored LEDs.
